(19) United States
(12) Patent Application Publication
(10) Pub. No.: US 2009/0287663 A1
(43) Pub. Date: Nov. 19, 2009

(54) DISEASE NAME INPUT SUPPORT PROGRAM, METHOD AND APPARATUS

(75) Inventor: Kiyoshi TAKEUCHI, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/504,347

(22) Filed: Jul. 16, 2009

Related U.S. Application Data
(63) Continuation of application No. PCT/JP2007/050808, filed on Jan. 19, 2007.

(51) Int. Cl. G06F 17/30

(52) U.S. Cl. 707/3; 707/E17.014; 707/104.1; 707/E17.044

(57) ABSTRACT

This disease name input support method includes: obtaining type data of a schema selected by a user and identification data of a region on the schema, which is identified by the user, and storing obtained data into a storage device; searching a disease name knowledge storage device storing an inputted disease name in association with the type data of the schema and the identification data of the region on the schema by using the obtained type data of the schema and the obtained identification data of the region on the schema, which are stored in the storage device, to extract a corresponding disease name; and presenting the extracted corresponding disease name as an input candidate disease name to the user.

### CROSS-REFERENCE TO RELATED APPLICATIONS

This application is a continuing application, filed under 35 U.S.C. section 111 (a), of International Application PCT/JP2007/050808, filed Jan. 19, 2007.

### FIELD

This technique relates to a technique to support inputs of disease names in an electronic medical record system.

### BACKGROUND

When a doctor treats a patient, he or she must write a disease name according to the treatment on a patient's medical sheet, or input it into the electronic medical record system through a disease name registration function thereof. However, typically, a disease name input support function in the current disease registration function merely infers a pertinent name of the disease from character information on the medical record.

However, a first conventional example discloses a technique enabling to automate a disease name diagnosis support in the treatment and to swiftly infer the disease name having high probability. Specifically, a nurse inputs present complaints and symptoms into a symptom input screen based on the patient's present complaints. Based on the information, an inferred disease name and inspection file is searched to output the inferred disease name and inspection into a disease name and inspection file for each patient and each present complaint. When a doctor issues an inspection order, required inspections registered in the disease name and inspection file for each patient and each present complaint are displayed, and the doctor adds or modifies them and issues the inspection order. Based on a specimen inspection result outputted by a specimen inspection system, which received a specimen inspection order in the inspection order, the inferred disease name is judged and registered. Then, an inferred disease name having high probability is displayed among from the inferred disease name from the present complaints and symptoms and the inferred disease name from the specimen inspection result.

In addition, a second conventional example discloses a technique to enable doctors to diagnose the patients much correctly and to make it possible to carry out appropriate treatment, medication, inspection and the like, even when the doctors have less experience or the doctors have to diagnose patients who are not in their field. Specifically, a client terminal is provided in a hospital, clinic, or the like, and the doctor inputs contents of the medical record when he or she diagnoses the patients, and the client terminal transmits the input data as the electronic medical record. In addition, a server apparatus is provided in a data center, stores the electronic medical records transmitted from the doctor through the client terminal, extracts keywords such as a diagnosis name, findings, inspection values and the like from the electronic medical record to store the extracted data into new databases, which are associated each other. A client terminal and server apparatus are connected through a network to provide a diagnosis support system.

Furthermore, a third conventional example discloses a technique to exactly extract symptoms or diagnosis names with high similarity by searching a clinical case information database storing a large amount of data in medical institutions by using an appearance pattern of the symptom as search words and individually comparing similarity between symptom lists. Specifically, a clinical case information search system having a clinical case information database storing clinical case information on the medical treatment, and search means for extracting predetermined clinical case information from the database has (a) symptom list input means for inputting symptoms of the clinical case; (b) symptom vector conversion means for converting the inputted symptom list into a symptom vector based on existence or degree of the symptom or the like; and (c) similarity calculation means for calculating similarity between the clinical case to be searched and the symptom vector of each clinical case, which has been recorded in the clinical case information database.

On the other hand, a fourth conventional example discloses a technique enabling to easily select an objective disease name by using a schema image when a user selects the disease name of the patient. Specifically, an apparatus has selection instruction accepting means for accepting a selection instruction of a schema image from a user; schema image extracting means for extracting a corresponding schema image from schema information storage means managing the schema images for each level, based on the schema image selection instruction accepted by the selection instruction accepting means; disease name extracting means for extracting a disease name corresponding to the level of the schema image extracted by the schema image extracting means, from disease name information storage means managing disease name information in association with the level; and display means for displaying the schema image extracted by the schema image extracting means and the disease name extracted by the disease name extracting means. Incidentally, the level of the schema image represents the whole, the abdomen, the stomach and the like.

However, the technique to infer the disease name based on the character information of the clinical record does not use the schema information that is characteristic image information included in the medical record, and cannot present the disease name with sufficient accuracy.

In addition, in the aforementioned disease name extraction technique using the schema, it cannot be said that the schema information is fully utilized.

### SUMMARY

According to one aspect of this technique, this disease name input support method includes: obtaining type data of a schema selected by a user and identification data of a region on the schema, which is identified by the user, and storing obtained data into a storage device; searching a disease name knowledge storage device storing an inputted disease name in association with the type data of the schema and the identification data of the region on the schema by using the type data of the schema and the identification data of the region on the schema, which are stored in the storage device, to extract a corresponding disease name; and presenting the extracted corresponding disease name as an input candidate disease name to the user.

According to another aspect of this technique, this disease name input support method includes: obtaining type data of a schema selected by a user and type data of a stamp selected by the user and disposed on the schema, and storing obtained data into a storage device; searching a disease name knowledge storage device storing an inputted disease name in association with the type data of the schema and the type data of the stamp disposed on the schema by using the obtained type data of the schema and the obtained type data of the stamp, which are stored in the storage device, to extract a corresponding disease name; and presenting the extracted corresponding disease name as an input candidate disease name to the user.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram depicting a system outline in an embodiment of this technique;

FIG. 2 is a functional block diagram of an electronic medical record system;

FIG. 3 is a diagram depicting an example of data stored in a medical record DB;

FIG. 4 is a diagram depicting an example of data stored in an individual disease name DB;

FIG. 5 is a diagram depicting an example of data stored in a disease name knowledge DB;

FIG. 6 is a diagram depicting an example of data stored in a template region master;

FIG. 7 is a diagram depicting an example of data stored in a stamp master;

FIG. 8 is a diagram depicting a screen example for selecting a schema;

FIG. 9 is a diagram depicting a screen example displaying the selected schema;

FIG. 10 is a diagram to explain an operation to paste the stamp to the schema;

FIG. 11 is a diagram depicting an example that the entry is made to the schema;

FIG. 12 is a diagram depicting a processing flow of a disease name input support processing;

FIG. 13 is a diagram depicting a display screen example of disease name candidates;

FIG. 14 is a diagram depicting a processing of a processing to register data into the disease name knowledge DB; and

FIG. 15 is a functional block diagram of a computer.

### DESCRIPTION OF EMBODIMENTS

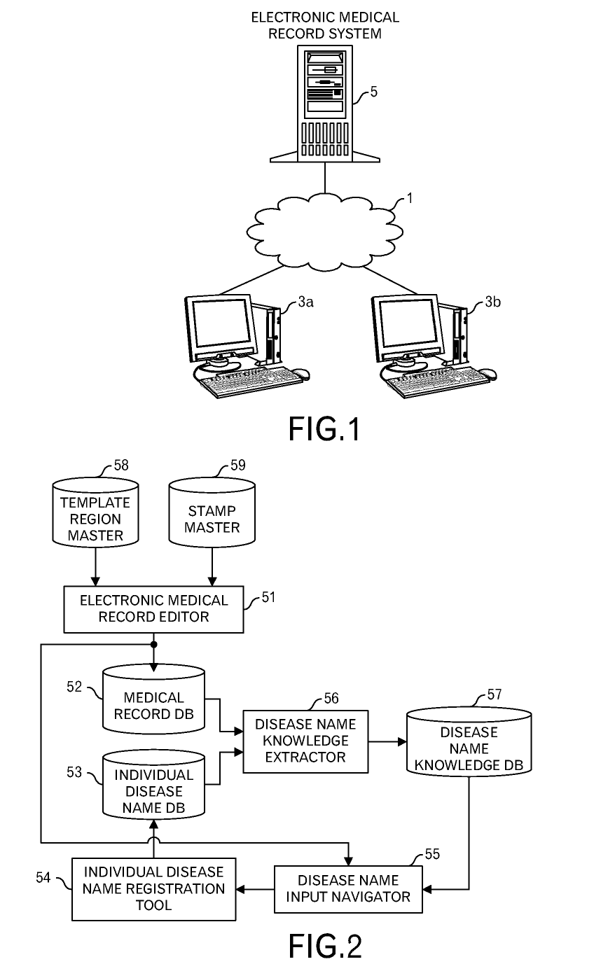

FIG. 1 depicts a system outline diagram relating to one embodiment of this technique. For example, plural user terminals 3 (3a and 3b in FIG. 1), which are personal computers operated by doctors or the like, and an electronic medical record system 5, which carries out a main processing in this embodiment, are connected to a network 1, which is a Local Area Network (LAN) in a hospital, for example. Incidentally, the user terminal 3 communicates with the electronic medical record system 5 by using, for example, a Web browser or dedicated client application. Although an example is explained that such a client server system is implemented, in the following, a stand-alone type system may be implemented.

FIG. 2 depicts a functional block diagram of the electronic medical record system 5. The electronic medical record system 5 has a template region master 58 storing data for schemas; a stamp master 59 storing data for stamps such as a tumor and a swelling, which are disposed on the schema; an electronic medical record editor 51 to realize well-known basic functions of the electronic medical record system 5 such as transmitting data for causing the user terminal 3 to carry out an input of the electronic medical record by using the template region master 58 and the stamp master 59, and receiving input data of the electronic medical record from the user terminal 3; a medical record DB 52 storing data of the electronic medical record inputted by the electronic medical record editor 51; a disease name knowledge DB 57 in which data to support the input of the disease name is accumulated; a disease name input navigator 55 that carries out, for the user terminal 3, a processing to support the user's input of the disease name, by using the disease name knowledge DB 57 based on data inputted to the electronic medical record editor 51; an individual disease name DB 53 in which data for the disease name of the patient is accumulated; an individual disease name registration tool 54 that receives the input data for the disease name of the patient, which was received by the disease name input navigator 55, from the disease name input navigator 55 and registers the input data into the individual disease name DB 53; and a disease name knowledge extractor 56 that extracts inference data to be registered into the disease name knowledge DB 57 by using data of the medical record DB 52 and the individual disease name DB 53, and registers the inference data into the disease name knowledge DB 57.

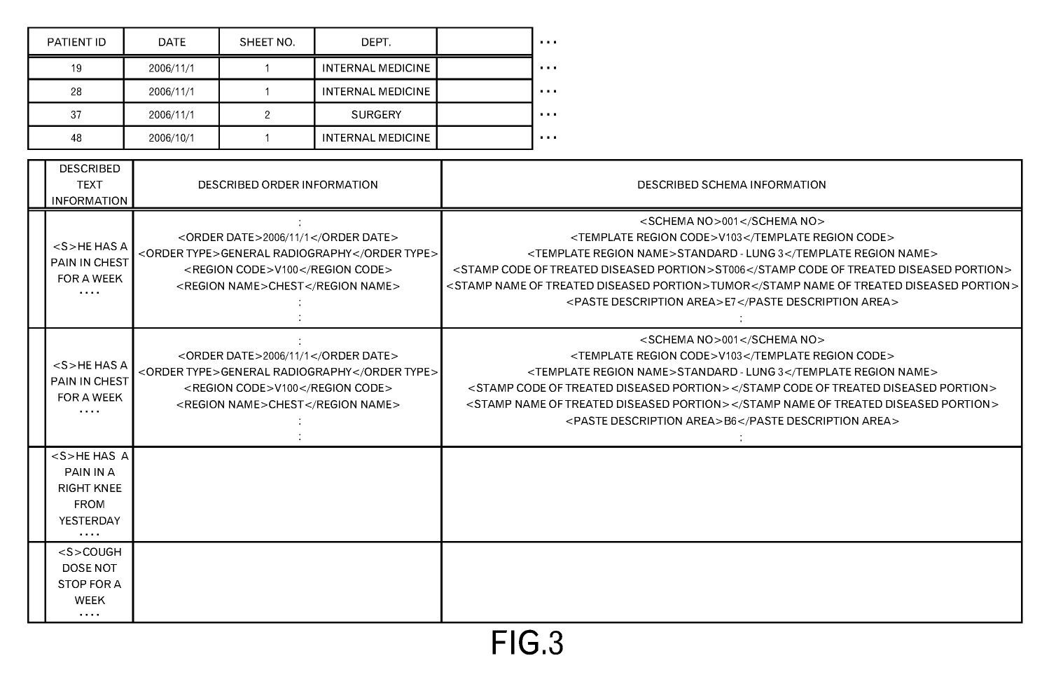

Next, FIG. 3 depicts an example of data stored in the medical record DB 52. In the example of FIG. 3, a patient ID, a date, a sheet number, a department such as an internal medicine or surgery, described test information, described order information, described schema information and the like are registered. Because the described schema information is mainly used in this embodiment, only the described schema information will be explained. A tag “schema no” represents a serial number of the schema used in one electronic medical record. A tag “template region code” represents a type of schema being used. A tag “template region name” represents a name of schema being used. A tag “stamp code of treated diseased portion” represents a type of stamp being used. A tag “stamp name of treated diseased portion” represents a name of stamp being used. A tag “paste description area” represents an area code of a region to which the stamp is disposed or any description or entry is made.

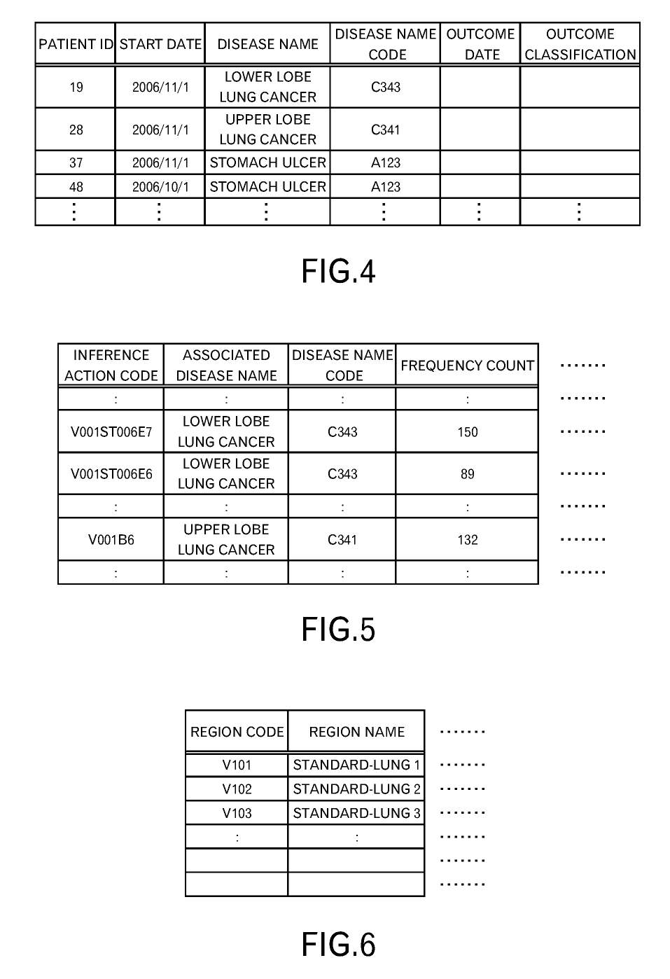

FIG. 4 depicts an example of data stored in the individual disease name DB 53. In the example of FIG. 4, a patient ID, a start date, a disease name, a disease name code, an outcome date, an outcome classification and the like are registered. The disease name is inputted by a disease name input support processing explained later or by a doctor.

FIG. 5 depicts an example of data stored in the disease name knowledge DB 57. In the example of FIG. 5, an inference action code as an extraction key, an associated disease name, a disease name code and a frequency count are registered. For example, the inference action code has such a format that the template region code of the schema, the stamp code and the paste description area code, which correspond to the associated disease name, are connected. Also in case where the inference data is generated based on elements other than the schema, the inference action code similarly has such a format that codes corresponding to the associated disease name are connected.

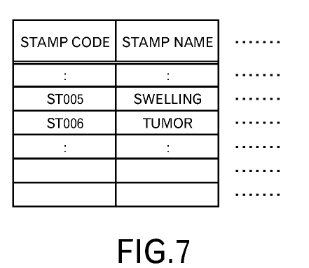

FIG. 6 depicts an example of data stored in the template region master 58. In the example of FIG. 6, the template region code is associated with the template region name. In addition, FIG. 7 depicts an example of data stored in the stamp master 59. In the example of FIG. 7, the stamp code is associated with the stamp name.

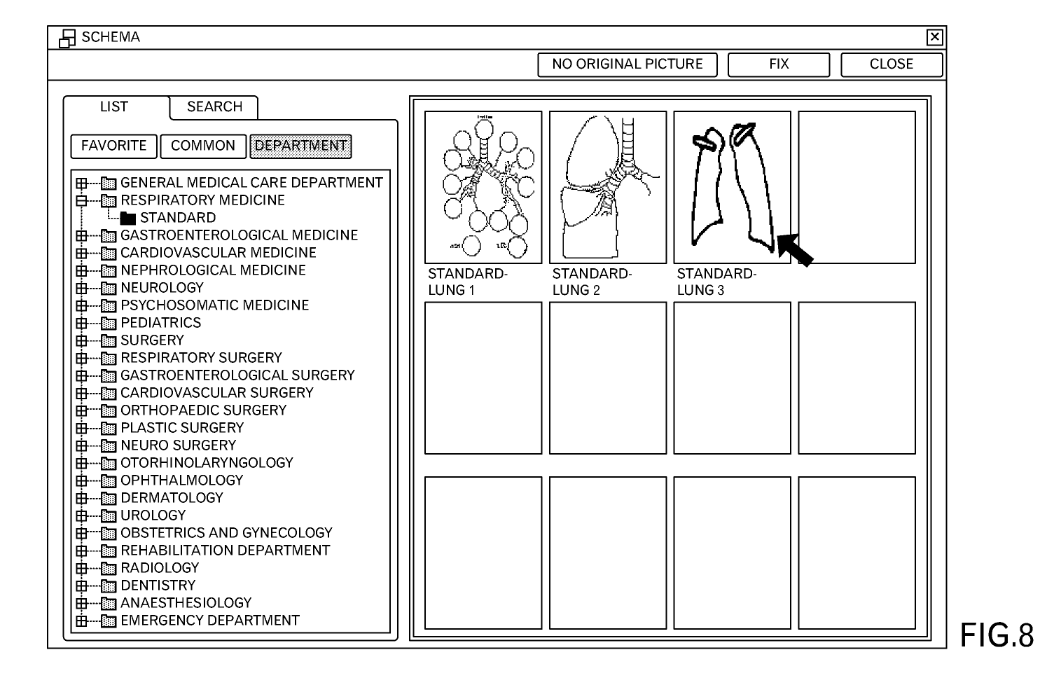

Next, a processing of the system depicted in FIGS. 1 and 2 will be explained by using FIGS. 8 to 14.

First, the electronic medical record editor 51 causes a display device of the user terminal 3 to display a screen as depicted in FIG. 8. The screen of FIG. 8 is a screen to select a schema to be used, and the screen enables the selection from a list of the schemas and the search of the schemas by selecting either tab therefor. In addition, FIG. 8 indicates a case where a schema is selected from the list, and the list is switched among a “favorite” list, “common” list and “department”-based list by selecting one of their buttons. FIG. 8 depicts the department-based list, and the schemas, which have been registered for each department, are displayed on the right side of the screen. In FIG. 8, three standard schemas in the respiratory medicine are depicted. The schemas as depicted in FIG. 8 are presented by reading out data from the template region master 58. The doctor or the like selects a schema to be used for the electronic medical record in this case by a mouse pointer. By the selection by using this mouse pointer, the electronic medical record editor 51 also identifies the template region code and the template region name.

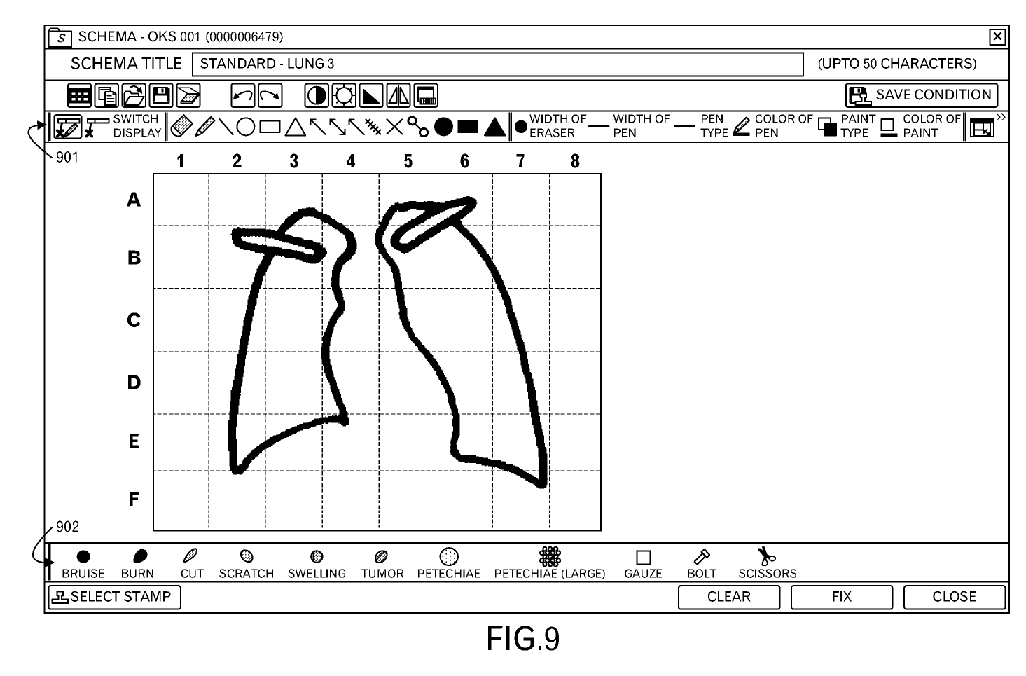

In response to the selection of the schema in FIG. 8, the electronic medical record editor 51 causes the display device of the user terminal 3 to display a screen as depicted in FIG. 9. The screen of FIG. 9 includes a display column of a schema title, buttons such as a file operation, buttons 901 of the drawing tools, a display column of the schema, a selection column 902 of the stamp, a stamp selection button for causing to display other stamps, a button for clearing the input contents, a fix button for fixing the input, and a close button for closing the window. The buttons 901 of the drawing tools are used in order to select any tool to freely carry out the drawing for the schema. In addition, the selection column 902 of the stamp lists marks (i.e. stamps) to indicate predetermined symptoms such as a bruise, burn, or cut on the schema. This column 902 is displayed by using data of the stamp master 59. In addition, in the display column of the schema, section division is carried out in order to identify a region to which the drawing is carried out by using the drawing tools or a region onto which the stamp is pasted, and in the example of FIG. 9, the schema is divided into sections A to F in the vertical direction, and is also divided into sections 1 to 8 in the horizontal direction. However, the section division may be carried out in other divisional modes.

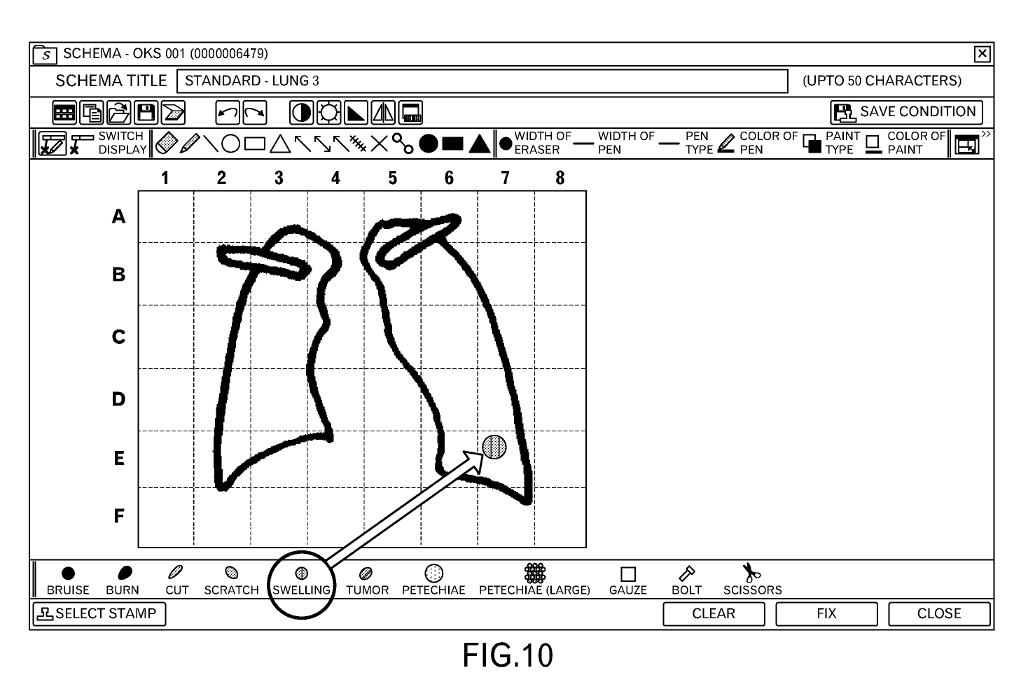

Next, a case where the doctor or the like pastes a stamp “swelling” will be explained by using FIG. 10. The doctor or the like operates the user terminal 3 to drag the stamp “swelling” and drop it onto a pertinent region. At this time, the electronic medical record editor 51 identifies which stamp is selected, namely, the stamp code and stamp name, and also identifies an area code (“E7”) onto which the stamp is dropped. Incidentally, the schema image created on the screen as depicted in FIG. 10 is stored into the medical record DB 52 or the like as it is.

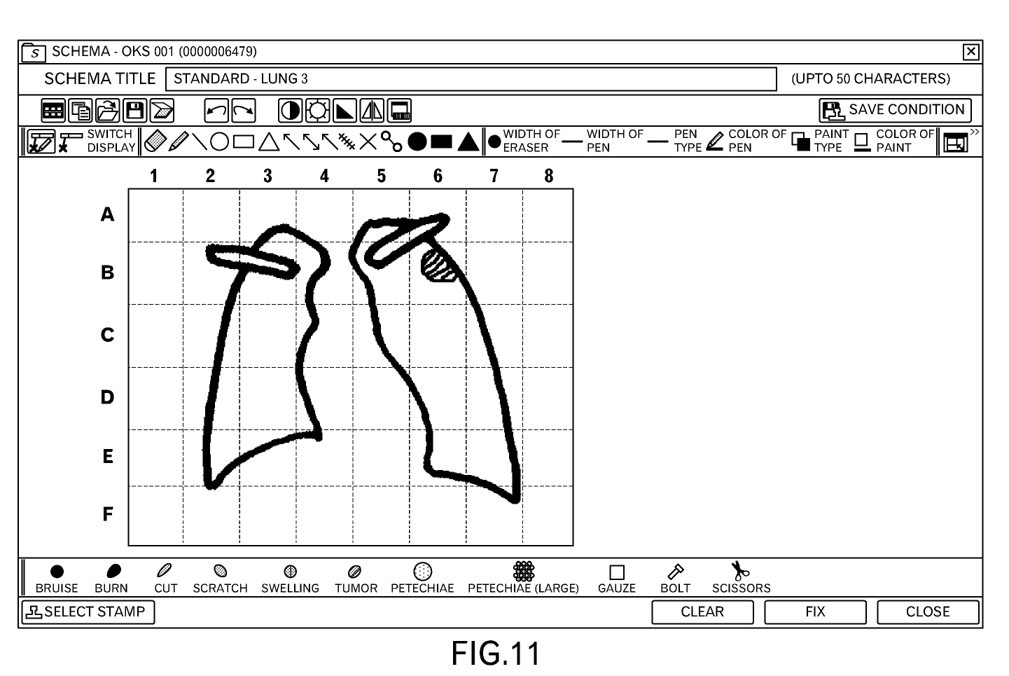

In addition, as depicted in FIG. 11, it is also possible for the doctor or the like to freely carry out the drawing onto the schema by using the drawing tools without using the stamps. In the example of FIG. 11, a sketch of the tumor is drawn in the section B6 by using a pen. In this case, the electronic medical record editor 51 identifies the section code onto which the drawing is made, as the paste description area code.

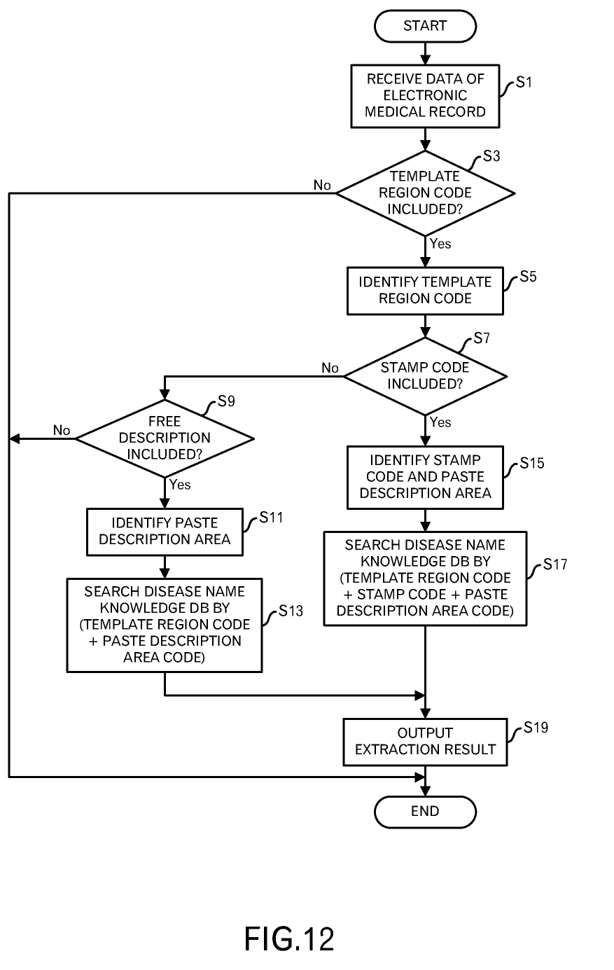

By carrying out such an input operation, the electronic medical record editor 51 identifies the template region code of the schema, the stamp code, the pate description area code and the like, and outputs them to the disease name input navigator 55. The disease name input navigator 55 and the individual disease name registration tool 54 carryout a disease name input support processing as depicted in FIG. 12.

The disease name input navigator 55 receives data of the electronic medical record from the electronic medical record editor 51 (step S1), and judges whether or not the received data includes the template region code (step S3). When the template region code is not included, the processing is terminated without carrying out anything, or a character-based disease name extraction processing, which is used in the conventional art, is carried out.

On the other hand, when the template region code is included, the disease name input navigator 55 identifies the template region code of the schema, and stores the code into a storage device such as a main memory (step S5). Then, the disease name input navigator 55 judges whether or not the received data includes the stamp code (step S7). When the stamp code is included, the disease name input navigator 55 identifies the stamp code and a code of the paste description area to which the stamp is pasted, and stores the stamp code and the code of the paste description area into the storage device such as the main memory (step S15). Then, the disease name input navigator 55 searches the column of the inference action code in the disease name knowledge DB 57 by using (template region code+stamp code+code of paste description area) to extract pertinent associated disease name and disease name code, and stores the extracted data into the storage device such as the main memory (step S17). In this extraction processing, plural associated disease names may be extracted. In such a case, the associated disease names are sorted in a descending order of the frequency count. Then, the disease name input navigator 55 outputs the extraction result to the individual disease name registration tool 54. The individual disease name registration tool 54 outputs the extraction result to the user terminal 3 to cause the user terminal 3 to display an inference candidate disease name display screen (step S19).

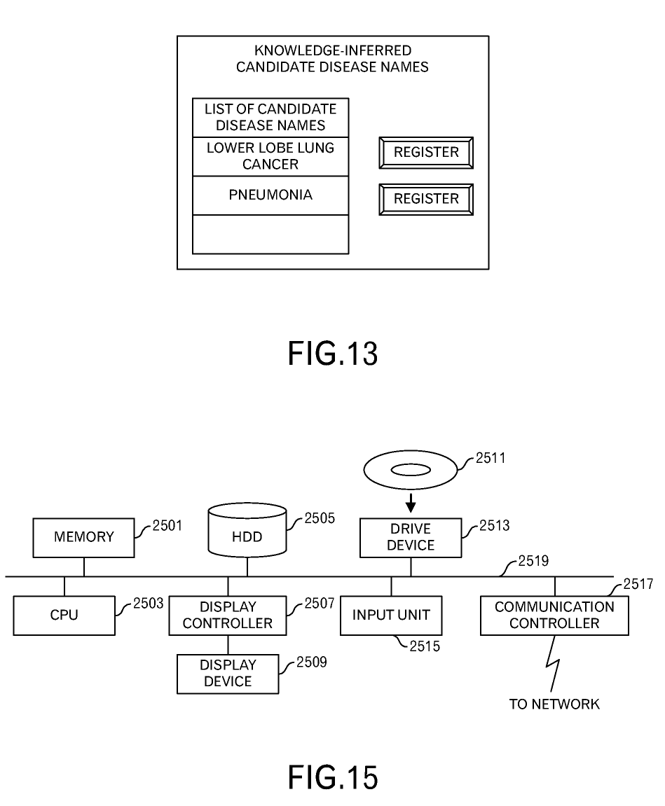

For example, a screen as depicted in FIG. 13 is displayed on the display device of the user terminal 3. In the example of FIG. 13, the candidate disease names “lower lobe lung cancer” and “pneumonia” are listed, and a “register” button is provided for each candidate disease name. As described above, the candidate disease names are listed in a descending order of the frequency count.

When such a display is carried out, the doctor or the like can refers to the disease names with higher probability, which were inferred from past input results, and when there is a pertinent disease name, he or she can register the disease name into the electronic medical record only by selecting the name. In the conventional art, the inference is carried out only by the character information or schema. However, in this embodiment, it is possible to present the disease name candidates with higher probability by using the stamp, paste description area and the like, which represent the symptoms more accurately.

On the other hand, when the stamp code is not included, the disease name input navigator 55 judges whether or not the received data includes the free description, by judging whether or not the received data includes the paste description area code (step S9). When the paste description area is not included and the free description is not included, the processing is terminated without carrying out anything, or the inference using only the schema or the character-based disease name extraction processing, which are used in the conventional arts, is carried out.

When the free description is included, the disease name input navigator 55 identifies the code of the paste description area, which is a section to which the drawing is made by using the drawing tool (step S11), and stores the identified code into the storage device such as the main memory. Then, the disease name input navigator 55 searches the column of the inference action code in the disease name knowledge DB 57 by using (template region code+paste description area code) to extract a pertinent associated disease name and disease name code, and stores the extracted data into the storage device such as the main memory (step S13). Then, the processing shifts to the step S19.

Also even in case where such a processing is carried out, it becomes possible to present the disease name candidates with higher probability by using not only the schema but also the paste description area.

Incidentally, at the steps S13 and S17, not only data associated with the inference action code completely identical to the search condition but also data associated with the inference action code partially identical to the search condition may be extracted.

In addition, the doctor or the like, who operates the user terminal 3, identifies the disease name, which seems to be appropriate, from the screen as depicted in FIG. 13, and when he or she clicks the corresponding “register” button, the individual disease name registration tool 54 obtains the disease name and disease name code, which correspond to the clicked “register” button, from the user terminal 3, and registers the disease name and disease name code into the individual disease name DB 53. As depicted in FIG. 4, the patient ID included in the data of the inputted electronic medical record, the disease name and the disease name code are registered into the individual disease name DB 53.

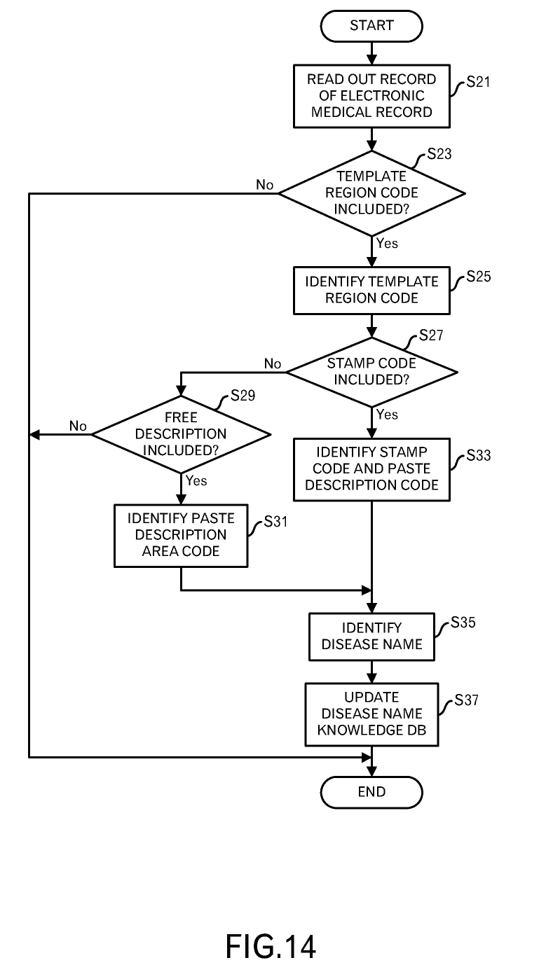

Next, a processing of the disease name knowledge extractor 56 will be explained by using FIG. 14. First, the disease name knowledge extractor 56 reads out a record of the electronic medical record (step S21). For example, a record of the newly registered electronic medical record is read out. Then, the disease name knowledge extractor 56 judges whether or not the record includes the template region code of the schema (step S23). Because the electronic medical record that does not include any schema exists, when the template region code is not included, the processing is terminated without carrying out anything or the processing similar to the conventional one is carried out and then the processing is terminated.

On the other hand, the disease name knowledge extractor 56 identifies the template region code, and stores the code into the storage device such as the main memory (step S25). Then, the disease name knowledge extractor 56 judges whether or not the record includes the stamp code (step S27). When the stamp code is not included, the disease name knowledge extractor 56 judges whether or not the record includes the free description, by judging whether or not the code of the paste description area is included (step S29). When it is determined that the code of the paste description area is not included and the free description is not included, the processing is terminated without carrying out anything, or after the processing similar to the conventional one is carried out, the processing is terminated.

On the other hand, when the code of the paste description area is included, the disease name knowledge extractor 56 identifies the code of the paste description code, and stores the code into the storage device such as the main memory (step S31). Then, the disease name knowledge extractor 56 searches the individual disease name DB 53 by data of the patient ID and the date, which are included in the data of the electronic medical record to identify the disease name, and stores the identified disease name into the storage device such as the main memory (step S35). After that, when passing through the step S31, the disease name knowledge extractor 56 generates the inference action code by connecting the template region code with the paste description area coder searches the disease name knowledge DB 57 by using the inference action code and the disease name, judges whether or not the record including the same data has been registered. When the record including the same data has been registered, the disease name knowledge extractor 56 increments the corresponding frequency count by “1”. On the other hand, when the record including the same data has not been registered, the disease name knowledge extractor 56 updates the disease name knowledge DB 57 by registering a new record including the inference action code, disease name and frequency count “1” into the disease name knowledge DB 57 (step S37). Then, the processing ends.

When it is determined at the step S27 that the stamp code is included, the disease name knowledge extractor 56 identifies the stamp code and the code of the paste description area, and stores the identified data into the storage device such as the main memory (step S33). Then, the processing shifts to the step S35. Incidentally, when passing through the step S33, at the step S37, the disease name knowledge extractor 56 generates the inference action code by connecting the template region code, the stamp code and the paste description area code, searches the disease name knowledge DB 57 by using the inference action code and the disease name, judges whether or not the record including the same data has been registered. When the record including the same data has been registered, the disease name knowledge extractor 56 increments the corresponding frequency count by “1”, and when the record including the same data has not been registered, the disease name knowledge extractor 56 updates the disease name knowledge DB 57 by registering a new record including the inference action code, disease name and the frequency count “1” in the disease name knowledge DB 57 (step S37).

When the aforementioned processing is carried out, the data used in the disease name input support processing explained in FIG. 12 is accumulated into the disease name knowledge DB 57.

Namely, the more the electronic medical record system 5 is used, the more data can be accumulated in the disease name knowledge DB 57, and the record with higher value of the frequency count can be presented. Thereby, the accuracy of the disease name candidates to be presented is improved.

Although the embodiment of this technique has been explained, this technique is not limited to this embodiment. For example, the functional blocks depicted in FIG. 2 may not always correspond to an actual program module configuration.

In addition, although the inference action code is generated by using only data associated with the schema in the aforementioned example, other closely associated character data may be combined.

Furthermore, the screen examples depicted above are merely examples, and other screen configuration may be adopted.

In addition, the electronic medical record system 5 may be configured by one computer or plural computers. Moreover, functions of the electronic medical record system 5 may be provided as a service by the Application Service Provider (ASP).

In addition, the user terminal 3 and the electronic medical record system 5 are computer devices as shown in FIG. 15. That is, a memory 2501 (storage device), a CPU 2503 (processor), a hard disk drive (HDD) 2505, a display controller 2507 connected to a display device 2509, a drive device 2513 for a removable disk 2511, an input device 2515, and a communication controller 2517 for connection with a network are connected through a bus 2519 as shown in FIG. 15. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform necessary operations. Besides, intermediate processing data is stored in the memory 2501, and if necessary, it is stored in the HDD 2505. In this embodiment of this invention, the application program to realize the aforementioned functions is stored in the removable disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the necessary application programs systematically cooperate with each other, so that various functions as described above in details are realized.

According to a first viewpoint of the aforementioned embodiment, this disease name input support method comprises: obtaining type data of a schema selected by a user and identification data of a region on the schema, which is identified by the user, and storing obtained data into a storage device; searching a disease name knowledge storage device storing an inputted disease name in association with the type data of the schema and the identification data of the region on the schema by using the type data of the schema and the identification data of the region on the schema, which are stored in the storage device, to extract a corresponding disease name; and presenting the extracted corresponding disease name as an input candidate disease name to the user. Because not only the type data of the schema, but also the identification data (e.g. region code) of the region on the schema, for example, to which a specific stamp was disposed or any entry was made, are used, it becomes possible to extract the disease name based on characteristic data of the schema. Namely, it becomes possible to present disease name candidates with high accuracy to the user.

According to a second viewpoint of the aforementioned embodiment, this disease name input support method includes: obtaining type data of a schema selected by a user and type data of a stamp selected by the user and disposed on the schema, and storing obtained data into a storage device; searching a disease name knowledge storage device storing an inputted disease name in association with the type data of the schema and the type data of the stamp disposed on the schema by using the obtained type data of the schema and the obtained type data of the stamp, which are stored in the storage device, to extract a corresponding disease name; and presenting the extracted corresponding disease name as an input candidate disease name to the user. Even such a method can extract the disease name based on the characteristic data of the schema, because not only the type data of the schema, but also the type data of the stamp representing, for example, a tumor or a bleeding are used. Namely, it becomes possible to present the disease name candidates with high accuracy to the user.

In the first viewpoint of this embodiment, the obtaining may include obtaining type data of a stamp disposed on a region of the schema, and storing the obtained data into the storage device. Then, the searching may include searching the disease name knowledge storage device by further using the type data of the stamp, which is stored in the storage device. It becomes possible to present the disease name candidates with further higher accuracy. Namely, it becomes possible to improve the business efficiency of the doctor.

Moreover, the disease name knowledge storage device may store frequency data for each record. Then, when a plurality of disease names are extracted in the searching, the presenting may include presenting the disease names in a descending order of values of the frequency data stored in the disease name knowledge storage device. By carrying out such a processing, the disease name candidate with higher probability may be easily selected.

In addition, the first viewpoint of the aforementioned embodiment may further include accepting an input of the disease name from the user; and storing the disease name inputted by the user in association with the type data of the schema selected by the user and the identification data of the region on the schema, which is identified by the user, into the disease name knowledge storage device. Thus, the disease name knowledge is accumulated, and it becomes possible to improve the accuracy.

Furthermore, the second viewpoint of the aforementioned embodiment may further include accepting an input of a disease name from the user; and storing the disease name inputted by the user in association with the type data of the schema selected by the user and the type data of the stamp selected by the user and disposed on the schema, into the disease name knowledge storage device.

Incidentally, a program for causing a computer to execute this disease name input support method can be created, and the program is stored in a computer-readable storage medium or a storage device such as flexible disk, CD-ROM, a magneto-optic disk, a semiconductor memory or hard disk. Incidentally, data during the processing is temporarily stored in a storage device such as a memory of a computer or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A computer-readable storage medium storing a program for causing a computer to execute a disease name input support process comprising:
obtaining type data of a schema selected by a user and identification data of a region on said schema, which is identified by said user, and storing the obtained type data of said schema and the obtained identification data of said region into a storage device;
searching a disease name knowledge storage device storing an inputted disease name in association with said type data of said schema and said identification data of said region on said schema by using the obtained type data of said schema and the obtained identification data of said region, which are stored in said storage device, to extract a corresponding disease name; and
presenting the extracted corresponding disease name as an input candidate disease name to the user.

2. A computer-readable storage medium storing a program for causing a computer to execute a disease name input support process comprising:
obtaining type data of a schema selected by a user and type data of a stamp selected by said user and disposed on said schema, and storing the obtained type data of said schema and the obtained type data of said stamp into a storage device;
searching a disease name knowledge storage device storing an inputted disease name in association with said type data of said schema and said type data of said stamp disposed on said schema by using the obtained type data of said schema and the obtained type of said stamp, which are stored in said storage device, to extract a corresponding disease name; and
presenting the extracted corresponding disease name as an input candidate disease name to said user.

3. The computer-readable storage medium as set forth in claim 1, wherein said obtaining comprises obtaining type data of a stamp disposed on said region of said schema, and storing the obtained type data of said stamp into said storage device, and
said searching comprises searching said disease name knowledge storage device by further using the obtained type data of said stamp, which is stored in said storage device.

4. The computer-readable storage medium as set forth in claim 1, wherein said disease name knowledge storage device stores frequency data for each combination of said type data of said schema and said identification data of said region on said schema, and
said presenting comprises presenting a plurality of disease names, which are extracted in said searching, in a descending order of values of said frequency data stored in said disease name knowledge storage device.

5. The computer-readable storage medium as set forth in claim 1, said process further comprising:
accepting an input of a disease name from said user; and
storing said disease name inputted by said user in association with said type data of said schema selected by said user and said identification data of said region on said schema, which is identified by said user, into said disease name knowledge storage device.

6. The computer-readable storage medium as set forth in claim 2, said process further comprising:
accepting an input of a disease name from said user; and
storing said disease name inputted by said user in association with said type data of said schema selected by said user and said type data of said stamp selected by said user and disposed on said schema, into said disease name knowledge storage device.

7. The computer-readable storage medium as set forth in claim 1, said process further comprising:
identifying said identification data of said region on said schema by detecting disposition of a stamp onto said schema by said user or entry onto said schema by said user.

8. A disease name input support apparatus, comprising:
a storage device;
an obtaining unit to obtain type data of a schema selected by a user and identification data of a region on said schema, which is identified by said user, and to store the obtained type data of said schema and the obtained identification data of said region into said storage device;
a disease name knowledge storage device storing an inputted disease name in association with said type data of said schema and said identification data of said region on said schema
a search unit to search said disease name knowledge storage device by using the obtained type data of said schema and the obtained identification data of said region, which are stored in said storage device, to extract a corresponding disease name; and
a presenting unit to present the extracted corresponding disease name as an input candidate disease name to the user.

9. A disease name input support apparatus, comprising:
a storage device;
an obtaining unit to obtain type data of a schema selected by a user and type data of a stamp selected by said user and disposed on said schema, and storing the obtained type data of said schema and the obtained type data of said stamp into said storage device;
a disease name knowledge storage device storing an inputted disease name in association with said type data of said schema and said type data of said stamp disposed on said schema
a search unit to search said disease name knowledge storage device by using the obtained type data of said schema and the obtained type of said stamp, which are stored in said storage device, to extract a corresponding disease name; and
a presenting unit to present the extracted corresponding disease name as an input candidate disease name to said user.
